(19) United States
(12) Patent Application Publication
(10) Pub. No.: US 2014/0094233 A1
(43) Pub. Date: Apr. 3, 2014

(54) GAMING METHOD INCLUDING RANDOMIZED POSSIBILITIES

(71) Applicant: Timothy C. Storm, Beloit, WI (US)

(72) Inventor: Timothy C. Storm, Beloit, WI (US)

(73) Assignee: MUSTERION, LLC, Beloit, WI (US)

(21) Appl. No.: 14/041,702

(22) Filed: Sep. 30, 2013

Related U.S. Application Data
(60) Provisional application No. 61/708,241, filed on Oct. 1, 2012.

(51) Int. Cl. G07F 17/32; A63F 9/24; A63F 1/00

(52) U.S. Cl. CPC G07F 17/3293; A63F 1/00; A63F 9/24
USPC 463/11; 273/292

(57) ABSTRACT

A method of playing a card game includes randomly dealing one or more cards from a standard card deck to at least one player. The card game allows for the at least one player to receive an additional card from the standard deck, and to place a first wager on the outcome of the card game. The first wager is associated with a first payout amount if the at least one player wins the card game. The method further includes selecting a subset of cards, that have not been dealt to the at least one player, from the standard card deck. The method includes adjusting the payout amount based on the subset of cards selected, and displaying the subset of cards to the at least one player. The method includes randomly selecting a card from the subset of cards, the randomly selected card dealt to the at least one player.

### CROSS-REFERENCE TO RELATED PATENT APPLICATIONS

This patent application claims the benefit of U.S. Provisional Patent Application No. 61/708,241, filed Oct. 1, 2012, the entire teachings and disclosure of which are incorporated herein by reference thereto.

### FIELD OF THE INVENTION

This invention generally relates to games of chance, and more particularly to methods and an apparatus to modify card games.

### BACKGROUND OF THE INVENTION

Card games involve at least one player, at least one deck of cards, and rules that define the player's actions during a game. Typically, card games begin with an initial dealing of cards from the deck of cards to players of the game. Usually the dealing is done by either a dealer or another player. Many times, these card games are played for the amusement of the players, especially in games where a player acts as the dealer. However, other times these games are played for the financial benefit or detriment of the players. Usually, when a game is played with financial ramifications it is played in a gaming house or casino, which can either be a physical location where players gather or even an online location where people access the online location from wherever they have access to the internet.

A casino is an organizer of games typically played for money. A casino allows patrons to play games and place bets on the outcome of the games they play. A casino usually operates to make a profit on the betting of the casino's patrons. In order to guarantee a stable income, a casino provides games that the casino can predetermine the odds that the casino or the player will win or lose. Usually, these odds are predetermined to provide the casino with a winning advantage.

Furthermore, by running games that allow the casino to predetermine the odds of the games being played the casino is inherently limiting the number and type of games that are played in the casino. In a competitive environment, casinos compete with each other for players patronage. One such way to distinguish between each casino is in the games offered. Typically, in casinos, players will want to play games that they think they can obtain a greater advantage of winning Therefore, another way to compete is to offer games that allow the player to feel more in control of the game they are playing.

In view of the above, there is a need for a card game that both allows a gaming house or casino the opportunity to predetermine odds of winning and losing and provides the player with the impression of having a better chance of winning as opposed to other potential games the player could be playing. The invention provides such a game. These and other advantages of the invention, as well as additional inventive features, will be apparent from the description of the invention provided herein.

### BRIEF SUMMARY OF THE INVENTION

In one aspect, embodiments of the invention provides a method of playing a card game that includes randomly dealing one or more cards from a standard card deck to at least one player. The card game allows for the at least one player to receive an additional card from the standard deck. The at least one player places a first wager on the outcome of the card game. The first wager is associated with a first payout amount if the at least one player wins the card game. The method further includes selecting a subset of cards, that have not been dealt to the at least one player, from the standard card deck. The method further includes adjusting the payout amount based on the subset of cards selected, and displaying the subset of cards to the at least one player. The method also includes randomly selecting a card from the subset of cards, the randomly selected card being dealt to the at least one player.

In a particular embodiment, selecting a subset of cards and adjusting the payout amount comprises selecting a subset of cards and adjusting the payout amount using a randomization device configured to track the cards dealt to the at least one player and to calculate the odds of a particular outcome. In a more particular embodiment, the card game is blackjack, and the randomization device indicates the play to be made by a dealer before the at least one player decides whether or not to take a randomly selected card from the subset of cards. In certain embodiments, the randomization device recalculates the payout amount for each subset of cards selected when the at least one player has an option to draw a card from the standard card deck. In an alternate embodiment, the card game is draw poker and the at least one player is a plurality of players, and wherein the randomization device selects a separate subset of cards from which one card is randomly selected before each card drawn by any of the plurality of players.

In another aspect, embodiments of the invention provide a method and apparatus for calculating the odds of a particular outcome based on the subset of cards selected. In a particular embodiment, the method further comprises randomly selecting an additional card randomly from the subset of cards. In still another aspect, embodiments of the invention provide a method that further includes adding the additional card to a group of community cards. In yet another aspect, embodiments of the invention provide a method that further comprises replacing the additional card in the subset of cards with a replacement card from the standard card deck.

In a particular aspect, embodiments of the invention include allowing the at least one player to place a side bet on the outcome of the selection of a subset of cards.

In another aspect, embodiments of the invention provide a method that further includes receiving, from the at least one player, a request for an additional card. The method then selects the additional card randomly from the subset of cards, and provides the additional card to the at least one player.

In yet another aspect, embodiments of the invention include allowing the at least one player to place a bet on the outcome of the card game. In another aspect, embodiments of the invention include determining the outcome of the card game by determining if the at least one player has a winning hand.

In yet another aspect, embodiments of the invention provide a randomization apparatus for randomly selecting a card from a group of cards from a standard card deck. The randomization apparatus includes a controller configured to track the cards dealt to at least one player and to calculate the odds of a particular outcome of a card game. The randomization apparatus includes a user interface, a card holder, a randomization block, and an indicator. The user interface allows an operator to start and stop the randomization apparatus. The card holder is adapted to hold a subset of cards from a deck of cards. The randomization block randomly picks a card from the subset of cards, and the indicator indicates the card from the subset of cards that the randomization block chose.

In another aspect, the card holder includes a weight sensor. The weight sensor allows the card holder to sense that the subset of cards is present on the card holder. In yet another aspect, the card holder includes a card reader that reads a face value of each individual card of the subset of cards on the card holder.

In another aspect, the randomization apparatus includes a memory device that stores a plurality of seed values for the randomization block. In yet another aspect, the memory device stores the face value of each individual card of the subset of cards on the card holder. In still another aspect, the face value of each individual card of the subset of cards on the card holder is used as seed values for the randomization block.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a depiction of a modified blackjack game in accordance with a particular embodiment of the present invention; and

FIG. 2 is an exemplary embodiment of the randomizing apparatus for randomly selecting a card.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

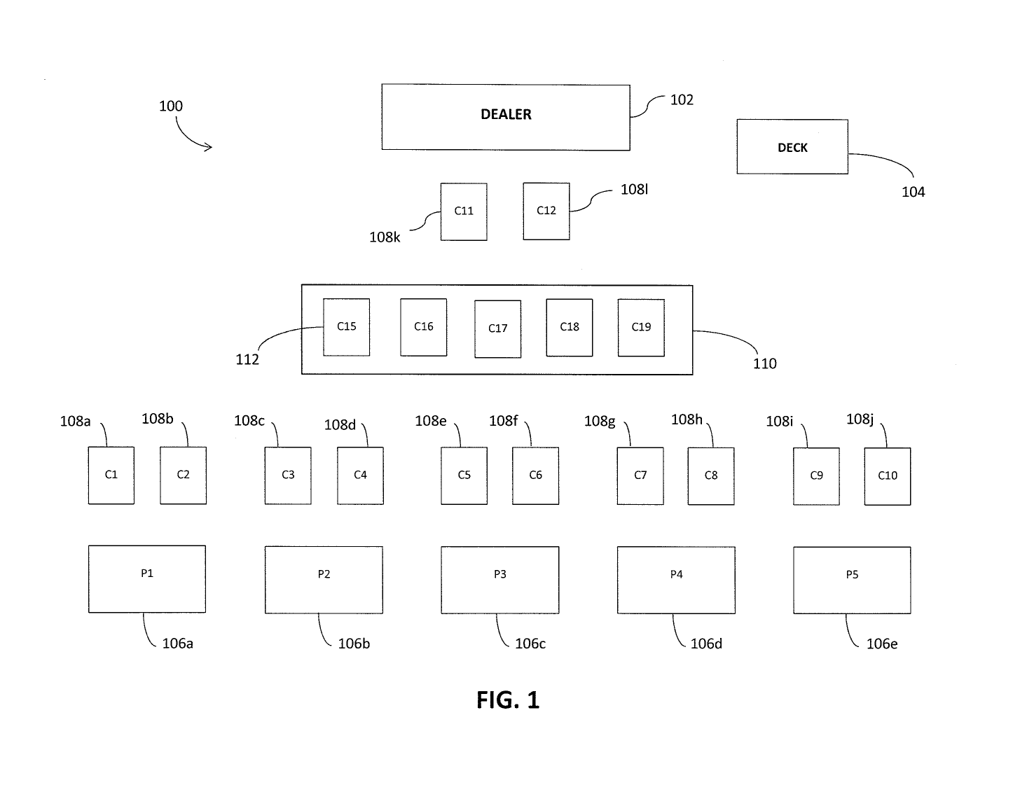

Turning now to FIG. 1, a depiction of a modified blackjack game 100 is illustrated. Please note that while the particular embodiment of the invention described below is done so in the context of blackjack, the invention applies to many card games such as poker or any game where a second dealing of cards is done subsequent to an initial dealing. Furthermore, in certain embodiments, a person of ordinary skill in the art would be capable of implementing the methods and apparatuses associated with the modified versions of the card games electronically in a computer readable medium.

FIG. 1 illustrates a modified version of blackjack 100 including a dealer 102 who deals cards 108a-108j to players 106 from a deck of cards 104. As is typical in blackjack, during the initial deal each player 106 receives two cards (e.g., 108a, 108b), and the dealer also receives two cards 108k, 108l. After the initial deal, each player 106 decides their next move based on the cards they were dealt during the initial deal. Typically, during blackjack the players 106 make a decision, based solely on the cards 108 that they have been dealt and other game play factors, that allow them to determine whether to stand, hit, double down, split, or surrender.

However, in this modified version of blackjack 100, the next five cards 112 from the deck 104 are displayed during a subsequent deal after the initial deal. As an aside, the particular embodiment illustrated in FIG. 1 shows five cards 112, but more or less are contemplated such that any subset of cards 112 dealt subsequent to an initial dealing of cards will suffice. Each player 106a-106e will each be presented with the option to hit in which case they would receive one of the cards 112 presented to them. Typically, if the player 106 chooses to hit they will receive a card 112 randomly picked from the cards 112 displayed. In certain embodiments, the selection of card 112 will be randomized by a randomization apparatus 110. After a subsequent card 112 is dealt, it is replaced by another card 112 from the deck 104, and the process repeats for the next player 106.

In other embodiments of the present invention, rather than presenting a subset of cards 112 to each individual player, the subset of cards 112 are presented to the players as a group. In this regard, if a player chooses to hit and thereby receives a card 112, that card 112 is not replaced by another card 112 from the deck 104. This particular embodiment then allows the next player to have an even further limited set of cards 112 of which a randomly selected card 112 will be dealt if the player chooses to hit.

In an even further embodiment of the present invention, rather than letting each player choose whether to hit from the subset of cards 112, in succession, the subset of cards 112 is presented to the players as a group. Prior to any card being dealt from the subset of cards, the players each decide individually if they would like to hit. Each player who decided to hit will receive a randomly selected card from the subset of cards 112. This particular style of play will speed up the game time because a new subset of cards will not have to be selected after each decision on whether to hit or not to hit is made by the player.

By providing a known group of cards 112, each player 106 is given additional information to determine the success of their next move in the game 100. This provides the players 106 with a greater confidence in their next move and a greater feel of control thereby increasing the desirability of the modified blackjack game 100. Further, in certain embodiments of the modified card game 100, players 106 will be able to place side bets on the outcome of a randomly chosen card from the subset of cards 112.

Additionally, the gaming house or casino is still able to set the odds of the modified blackjack game 100. Typically, the rules of any game ran by a casino are set such that they favor the house thereby providing a statistical advantage to the house that operates the card game. Specific to blackjack, factors such as number of decks of cards used during the game, when the dealer stands and when the dealer hits, whether the deck is shuffled after each hand, and various rules associated with splits are a few of the variables casinos will employ to affect predetermined odds of winning or losing. The modified version of blackjack 100 still allows a casino running the game the opportunity to control the odds of winning or losing.

Essentially, the casino would have one more variable that could potentially be used to alter the odds of a player 106 winning or losing. Typically, for blackjack, a casino sets odds based on an ideal game play where players make the most rational choice as determined by the cards presented to them and the dealer. In the modified version of blackjack 100, the odds would be set in a similar fashion except now they would have to take into account that the players decision making will be heavily based on the subset of cards 112. Using this information, the casino may make alterations such as betting limits, payouts, or alterations to any of the previously mentioned factors typically used to set odds in blackjack. In an alternate embodiment of the invention, the randomization apparatus is configured to indicate to the players how the dealer will play his/her hand (e.g., whether or not to take a hit) before the player sees the subset of cards or is randomly dealt one of the subset of cards. The randomization apparatus may also recalculate the odds of winning or the payout amounts based on the cards in the subset of cards.

In an alternative embodiment, the card game does not deal one of the cards 112 to an individual player. Rather, the game uses the turned over cards 112 as potential community cards. This configuration is similar to community card variants of poker (such as Texas Hold'em or Omaha) where players assess how much money to bet based on their individual playing hand and community cards displayed. In this modified version of poker an individual player is allowed to make decisions based on a likelihood of one or more of the turned over cards 112 being randomly chosen as the community card(s). Also, in certain embodiments of the community card game variants, the specific card selected from the subset of cards 112 to be added to the community cards of the game, may or may not be replaced in the subset of cards 112 by another card from the deck for an additional subsequent dealing.

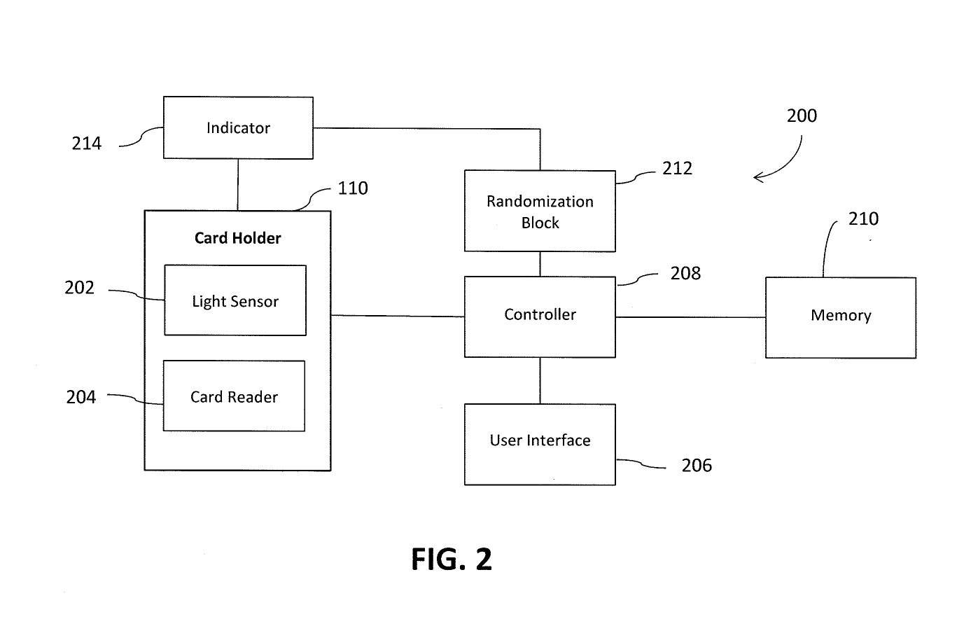

FIG. 2 illustrates a block diagram 200 of the randomization apparatus 110 from FIG. 1. Cards 112 are placed onto the card holder 110, which in certain embodiments may contain a sensor 202 to detect that cards 112 have been placed on the holder 110. In other embodiments of the card holder 110, a card reader 204 may be integrated into the card holder 110. The card reader 204 detects the specific face value of the card and provides that information to a controller 208 to store the values in a memory 210. In a particular embodiment, the controller 208 is configured to track the values of the cards dealt to the players, and further configured to calculate the odds of a particular outcome of the card game. The stored card face values can then be used to seed a randomization block 212. The ability to know what cards are contained on the randomization apparatus 110 would allow the casino to predetermine odds of a player winning or losing with greater ease.

In certain embodiments, the cards 112 should face upward such that the players 106 can see the face value of the cards 112. Once the cards 112 are in place, a player 106 is then given the opportunity to decide if they would like to have a card 112 randomly selected. If the player 106 would like to have a card 112, then the dealer 102 initiates the randomization apparatus via a user interface 206. The user interface 206 communicates with a controller 208, which seeds the randomization block 212 with information stored in a memory device 210. The randomization block 212 randomly selects one of the cards displayed on the card holder 110. The selection is indicated by an indicator 214. The player 106 is then given the card highlighted by the indicator 214.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of playing a card game, comprising:
randomly dealing one or more cards from a standard card deck to at least one player, wherein the card game allows for the at least one player to receive an additional card from the standard deck, and wherein the at least one player places a first wager on the outcome of the card game, the first wager being associated with a first payout amount if the at least one player wins the card game;
selecting a subset of cards, that have not been dealt to the at least one player, from the standard card deck;
adjusting the payout amount based on the subset of cards selected;
displaying the subset of cards to the at least one player;
randomly selecting a card from the subset of cards, the randomly selected card being dealt to the at least one player.

2. The method of claim 1, further comprising adding the selected card to a group of community cards.

3. The method of claim 1, further comprising replacing the selected card in the subset of cards with a replacement card from the standard card deck.

4. The method of claim 1, wherein selecting a subset of cards and adjusting the payout amount comprises selecting a subset of cards and adjusting the payout amount using a randomization device configured to track the cards dealt to the at least one player and to calculate the odds of a particular outcome.

5. The method of claim 4, wherein the card game is blackjack, and the randomization device indicates the play to be made by a dealer before the at least one player decides whether or not to take a randomly selected card from the subset of cards.

6. The method of claim 5, wherein the randomization device recalculates the payout amount for each subset of cards selected when the at least one player has an option to draw a card from the standard card deck.

7. The method of claim 4, wherein the card game is draw poker and the at least one player is a plurality of players, and wherein the randomization device selects a separate subset of cards from which one card is randomly selected before each card drawn by any of the plurality of players.

8. The method of claim 1, further comprising allowing the at least one player to place a second wager after the subset of cards is displayed.

9. The method of claim 1, further comprising:
receiving a request from the at least one player for an additional card;
selecting the additional card randomly from the subset of cards; and
providing the additional card to the at least one player.

10. A randomization apparatus for randomly selecting a card from a group of cards in a standard card deck, comprising:
a controller configured to track the cards dealt to at least one player and to calculate the odds of a particular outcome in a card game;
a user interface that allows an operator to start and stop the randomization apparatus;
a card holder adapted to hold a subset of cards from a deck of cards;
a randomization block that randomly selects a card from the subset of cards; and
an indicator that indicates the card from the subset of cards that the randomization block selected.

11. The randomization apparatus of claim 10, wherein the card holder includes a sensor that allows the card holder to sense that the subset of cards are present on the card holder.

12. The randomization apparatus of claim 10, wherein the card holder includes a card reader that reads a face value of each individual card of the subset of cards on the card holder.

13. The randomization apparatus of claim 10, further comprising a memory device that stores a plurality of seed values for the randomization block.

14. The randomization apparatus of claim 10, further comprising a memory device that stores the face value of each individual card of the subset of cards on the card holder.

15. The randomization apparatus of claim 14, wherein the face value of each individual card of the subset of cards on the card holder is used as seed values for the randomization block.
